(19) United States
(12) Patent Application Publication
(10) Pub. No.: US 2013/0276607 A1
(43) Pub. Date: Oct. 24, 2013

(54) CUTTING PLOTTER

(71) Applicants: Mitsuhiro Iida, Nagoya-shi (JP); Tomoyasu Niizeki, Ichinomiya-shi (JP)

(72) Inventors: Mitsuhiro Iida, Nagoya-shi (JP); Tomoyasu Niizeki, Ichinomiya-shi (JP)

(73) Assignee: Brother Kogyo Kabushiki Kaisha, Nagoya-shi (JP)

(21) Appl. No.: 13/847,933

(22) Filed: Mar. 20, 2013

(30) Foreign Application Priority Data
Mar. 22, 2012 (JP) 2012-065488

(51) Int. Cl. B26D 7/01

(52) U.S. Cl. CPC B26D 7/015
USPC 83/374

(57) ABSTRACT

A cutting plotter includes a cutting mechanism, a retaining mechanism and a press mechanism. The cutting mechanism includes a cutter. The cutter has a blade edge on a head of the cutter. The retaining mechanism retains the cutter to allow the cutter to change an orientation of the blade edge. The press mechanism includes a press member. The press member is configured to interlock with the cutter and to press a cutting object near the blade edge. The press mechanism is configured to maintain a positional relationship between the press member and the blade edge when the orientation of the blade edge changes in a relative movement between the cutting, mechanism and the object.

### CROSS-REFERENCE TO RELATED APPLICATIONS

This application claims priority to Japanese Patent Application No. 2012-65488 filed on Mar. 22, 2012, the content of which is hereby incorporated herein by reference in its entirety.

### BACKGROUND

1. Technical Field

The present disclosure relates to a cutting plotter that cuts a pattern from a cutting object.

2. Description of Related Art

Conventionally, a cutting plotter that automatically cuts a sheet, e.g., paper, has been known. The cutting plotter moves the sheet in a first direction by rollers of a moving mechanism that pinch the sheet in an up-down direction. The cutting plotter moves a carriage including a cutter in a second direction perpendicular to the first direction. The sheet is cut by relative movements between the sheet and the cutter.

The cutter includes a cutter shaft and a blade edge. The cutter shaft has a rod-like shape extending in the up-down direction. The blade edge is formed in a bottom of the cutter shaft. The cutter is retained in the carriage so as to be pivotable about an axis of the cutter shaft. A tip of the blade edge is eccentric with respect to the cutter shaft.

When the sheet is cut by the relative movements between the sheets and the cutter, the tip of the blade edge receives friction from the sheet. Thus, in the cutter described above, an orientation of the blade edge changes automatically in response to a direction of a movement of the cutter with respect to the sheet.

In the cutting plotters described above, a biasing plate that presses the sheet from above is provided. The biasing plate has a horseshoe shape in a plane view. The biasing plate has a pair of pressing portions provided in both sides of the cutter. The pressing portions are connected to each other in base ends thereof. The pressing portions press the sheet to prevent the sheet from floating.

However, the pressing portions of the conventional biasing plate are away from the blade edge of the cutter in some degree when the biasing plate presses the sheet. Thus, it is difficult to reliably prevent the sheet from floating and turning. When a corner of a cutting line of the sheet is cut, the blade edge of the cutter pivots to change the orientation of the blade edge. Turning of the sheet may arise due to the pivot of the blade edge, although the biasing plate presses the sheet.

In order to solve this problem, it is likely to dispose the pressing portion of the biasing plate in a position as close as possible to the blade edge of the cutter. However, because the blade edge pivots about the axis of the cutter shaft, an appropriate gap is provided between the pressing portion and the blade edge to avoid a collision between the pressing portion and the blade edge. Therefore, it is difficult to dispose the pressing portion in a position as close as possible to the blade edge.

### SUMMARY

A purpose of the present disclosure is to provide a cutting plotter that allows a press mechanism to be disposed in a position as close as possible to the blade edge, thereby reliably pressing the cutting object.

An aspect of the present disclosure is a cutting plotter that includes a cutting mechanism, a retaining mechanism, and a press mechanism. The cutting mechanism includes a cutter. The cutter has a blade edge on a head of the cutter. The retaining mechanism retains the cutter to allow the cutter to change an orientation of the blade edge. The press mechanism includes a press member. The press member is configured to interlock with the cutter and to press a cutting object near the blade edge. The press mechanism is configured to maintain a positional relationship between the press member and the blade edge when the orientation of the blade edge changes in a relative movement between the cutting mechanism and the cutting object.

Another aspect of the present disclosure is a cutting plotter that includes a cutting mechanism, a retaining mechanism, and a press mechanism. The cutting mechanism includes a cutter. The cutter has a blade edge on a head of the cutter and a tip of the blade edge. The tip of the blade edge is eccentric with respect to a central axis of a base portion of the cutter. The base portion extends in one direction. The retaining mechanism retains the cutter pivotably about the central axis. The press mechanism includes a press member. The press member surrounds the blade edge and is configured to pivotably interlock with the cutter and to press a cutting object. The press mechanism is configured to maintain a positional relationship between the press member and the blade edge by a pivot of the press member when an orientation of the blade edge changes due to a pivot of the cutter about the central axis in to relative movement between the cutting mechanism and the cutting object by a pivot of the press member.

### BRIEF DESCRIPTION OF THE DRAWINGS

FIG. 1 is a perspective view of the inner structure of a cutting plotter according to one configuration;

FIG. 2 is a front view of the cutting plotter;

FIGS. 3A and 3B are a perspective view of a cutter holder assembled to a carriage and a perspective view of the stand-alone carriage respectively;

FIGS. 4A, 4B and 4C are a front view and a plan view of the cutter holder together with the carriage and a sectional view taken along line IVc-IVc in FIG. 4B, respectively;

FIG. 5 is an enlarged view of the distal end of the cutter and its vicinity during a cutting operation;

FIGS. 6A to 6E are a front view, a left side view, a longitudinally sectional left side view (a sectional view taken along line VIc-VIc in FIG. 6A), a bottom view and a transversely sectional bottom view of a cutting unit with the cutter holder being located at an ascended position (a sectional view taken along line VIe-VIe in FIG. 6B) respectively;

FIGS. 7A to 7D are views similar to FIGS. 6A to 6D, showing the state during feeding, respectively;

FIGS. 8A to 8D are views similar to FIGS. 7A to 7D with the cutter holder being located at a lowered position respectively;

FIG. 9 is a schematic block diagram showing an electrical arrangement of the cutting plotter;

FIG. 10 shows an example of cutting line in an object to be cut;

FIGS. 11A, 11B and 11C are a front view, a longitudinally sectional side view to sectional view taken along line XIb-XIb in FIG. 11A) and a bottom view of the cutting unit in a second configuration;

FIGS. 12A, 12B and 12C are views similar to FIGS. 11A to 11C, showing the cutting unit slightly away from the object, respectively; and

FIGS. 13A to 13C are views similar to FIGS. 11A to 11C with the cutter holder being located at the lowered position respectively.

### DETAILED DESCRIPTION

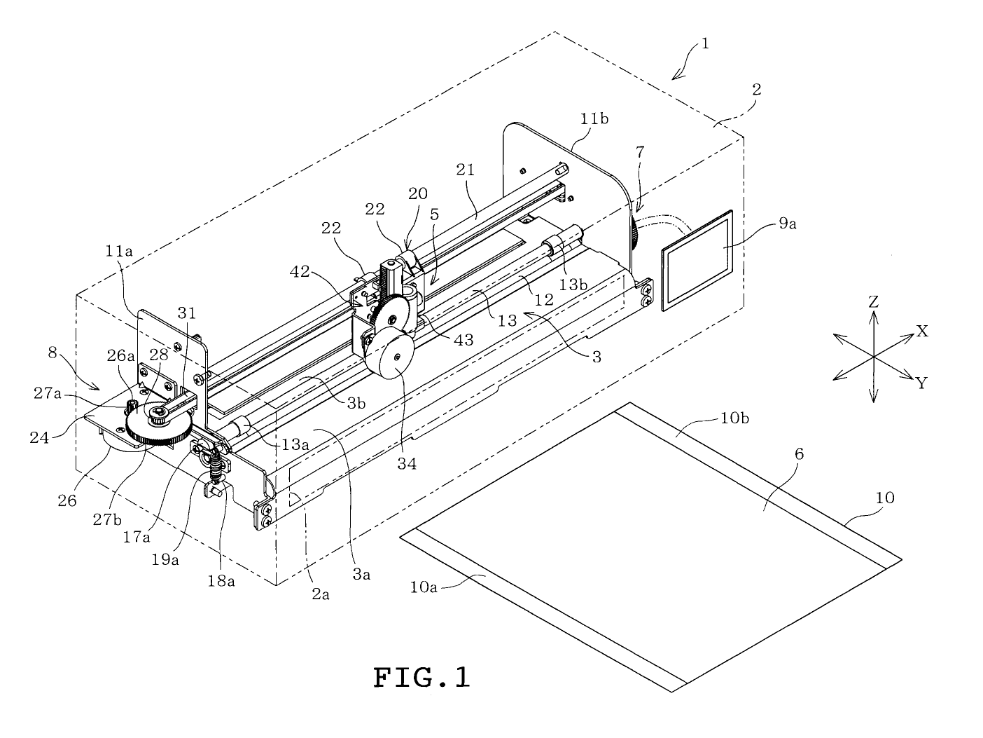

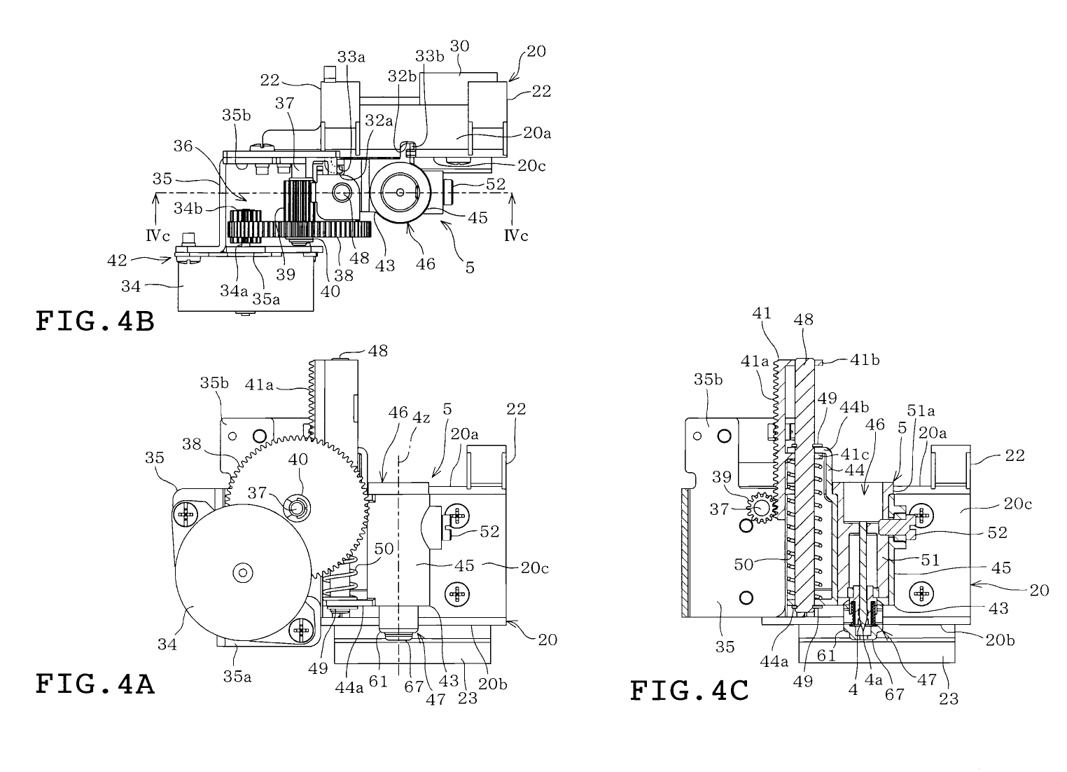

A first configuration will be described with reference to FIGS. 1 to 10. Referring to FIG. 1, a cutting plotter 1 includes a body cover 2 as a housing, a platen 3 provided in the body cover 2 and a cutter holder 5 holding a cutter 4 (see FIG. 4C). The cutting plotter 1 also includes a carriage 20 supporting the cutter holder 5 and first and second moving units 7 and 8 for moving the cutter 4 and an object 6 to be cut relative to each other. The body cover 2 is formed into a horizontally long rectangular shape. The body cover 2 has a front formed with a horizontally long opening 2a through which a holding sheet 10 holding the object 6 thereof is to be set on an upper surface of the platen 3. In the following description, the side where the user is located relative to the cutting plotter 1 will be referred to as “front” and the opposite side as “back.” A front-back direction will be referred to as “Y direction” and a right-left direction perpendicular to the Y-direction will be referred to as “X direction.”

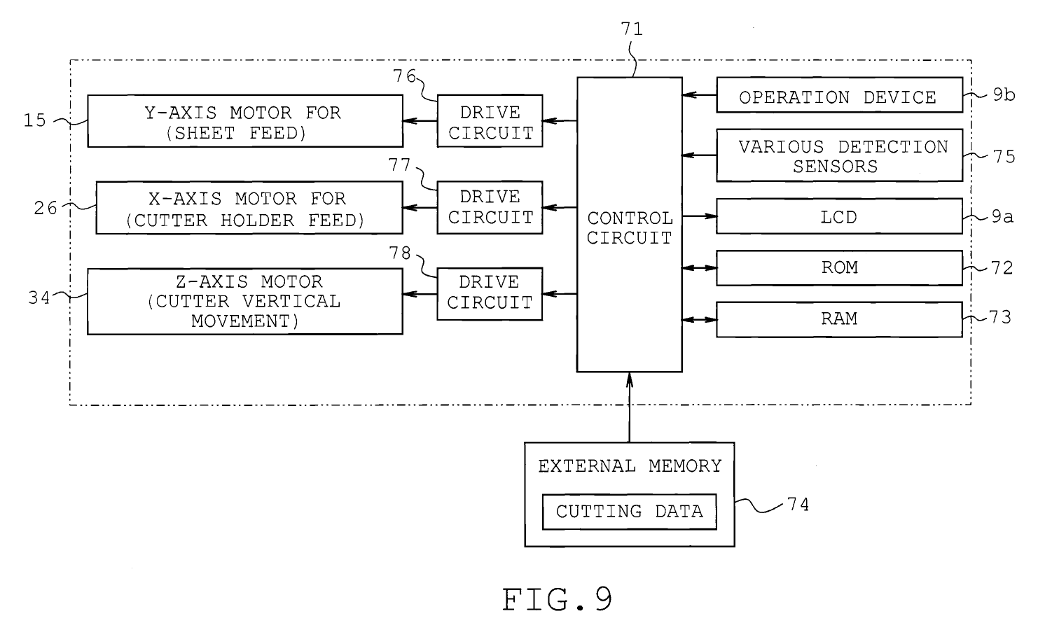

On a right part of the body cover 2 are provided a liquid crystal display (LCD) 9 and an operation device 9b (see FIG. 9) which includes a plurality of operation switches (see FIG. 9). The LCD 9 is configured as a display unit displaying various messages for the user, and the like. The operation device 9b is operable for the user to carry out various instructions, selections and input.

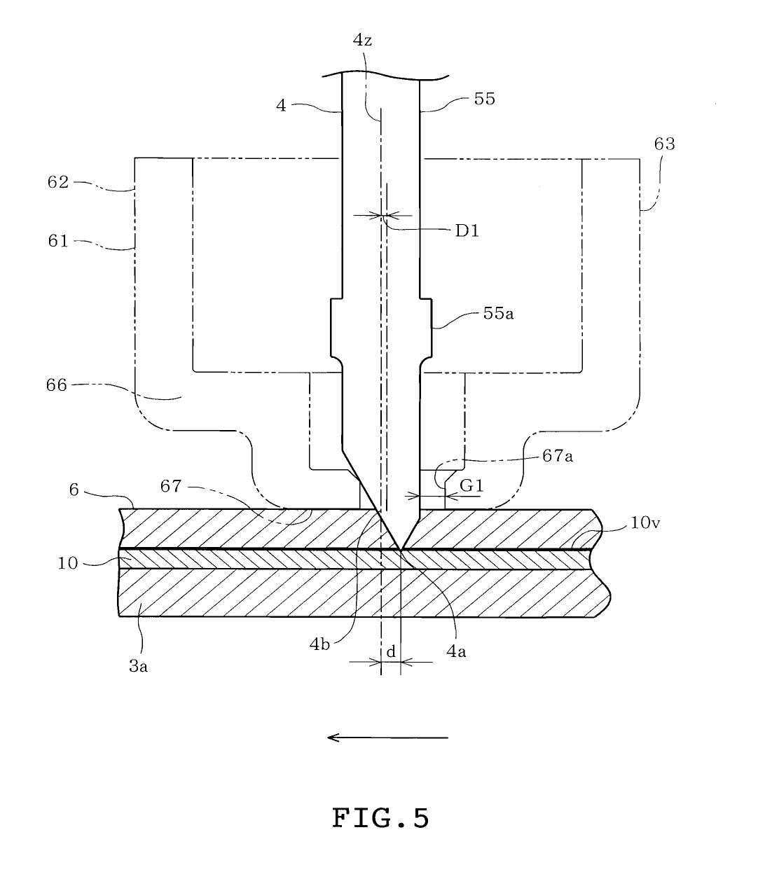

The platen 3 includes a pair of front and back plate members 3a and 3b and has an upper surface formed into a horizontal plane or an X-Y plane. The holding sheet 10 is received by the platen 3 when the object 6 is cut. The holding sheet 10 has an adhesive layer 10v (see FIG. 5) formed by applying an adhesive agent to the upper surface thereof, more specifically, on an inner area thereof except for right and left edges 10a and 10b. The user affixes the object 6 to the adhesive layer 10v, whereby the object 6 is held on the holding sheet 10.

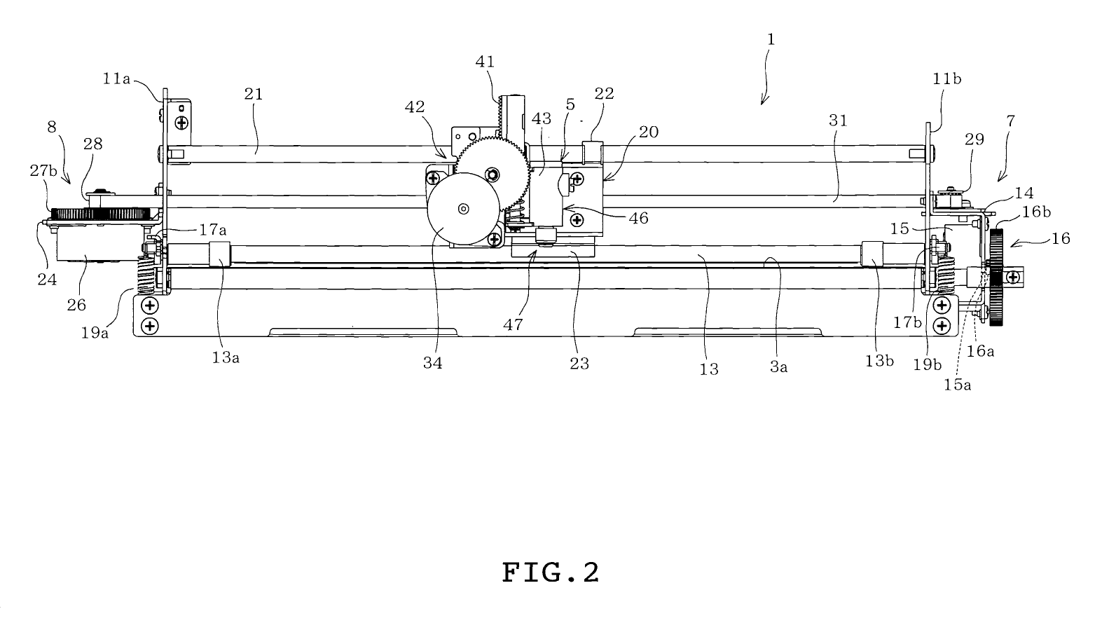

The first moving unit 7 moves the holding sheet 10 on the upper surface side of the platen 3 in the Y direction (a first direction). More specifically, a driving roller 12 and a pinch roller 13 are provided on right and left sidewalls 11b and 11a so as to be located between plate members 3a and 3b of the platen 3. The driving roller 12 and the pinch roller 13 extend in the X direction and are rotatably supported on the sidewalls 11b and 11a. The driving roller 12 and the pinch roller 13 are disposed so as to be parallel to the horizontal plane and so as to be vertically arranged so that the driving roller 12 is located lower and the pinch roller 13 is located above. A first crank-shaped mounting frame 14 is mounted on the right sidewall 11b so as to be located on the right of the driving roller 12 as shown in FIG. 2. A Y-axis motor 15 is fixed to an outer surface of the mounting name 14.

The Y-axis motor 15 includes a stepping motor, for example and has a rotating shaft 15a extending through the first mounting frame 14. The Y-axis motor 15 has a distal end to which a driving gear 16a is fixed. The driving roller 12 has a right end to which is fixed a driven gear 16b which is brought into mesh engagement with the driving gear 16a. These gears 16a and lob constitute a first reduction gear mechanism 16 Two spring hook members 17a and 17b are formed on the sidewalls 11a and 11b so as to cover both ends of the pinch roller 13 respectively, although not shown in detail. Two tension coil springs 19a and 19b extend between the spring hook members 17a and 17b and spring mounts (only a left one 18a is shown) respectively. Accordingly, the pinch roller 13 is normally biased downward by the tension coil springs 19a and 19b. The pinch roller 13 is provided with a pair of right and left pressing portions 13a and 13b formed on portions thereof near the sidewalls 11a and 11b respectively. The pressing portions 13a and 13b have respective slightly larger outer diameters than the other portions of the pinch roller 13. The pressing portions 13a and 13b are brought into contact with left and right edges 10a and 10b of the holding sheet 10, thereby pressing the edges 10a and 10b, respectively. A carriage 20 supporting the cutter holder 5 is slidable on the pinch roller 13 between the pressing portions 13a and 13b.

The driving roller 12 and the pinch roller 13 press the holding sheet 10 from below and from above by the urging force of the tension coil springs 19a and 19b thereby to hold the holding sheet 10 therebetween. Upon normal or reverse rotation of the Y-axis motor 15, rotational movement of the Y-axis motor 15 is transmitted via the first reduction gear mechanism 16 to the driving roller 12, whereby the holding sheet 10 is moved backward or forward together with the object 6. The first moving unit 7 is thus constituted by the driving roller 12, the pinch roller 13, the Y-axis motor 15, the first reduction gear mechanism 16, the tension coil springs 19a and 19a and the like.

The second moving unit 8 moves a carriage 20 together with the cutter holder 5 in the X direction (a second direction). In more detail, a guide shaft 21 is provided between the sidewalls 11a and 11b so as to be located on upper ends of the sidewalls 11a and 11b and so as to extend in the right-left direction, as shown in FIGS. 1 and 2. The guide shaft 21 is disposed in parallel with the driving roller 12 and the pinch roller 13 and extends through an aperture 22 which is formed m an upper part of the carriage 20 as will be described later. The carriage 20 is guided by the guide shaft 21 so as to be slidable in the right-left direction.

A second generally L-shaped mounting frame 24 is mounted on the left sidewall 11a in the rear of the cutting apparatus 1 as shown in FIGS. 1 and 2. An X-axis motor 26 and a second reduction gear mechanism 27 are provided on the second mounting frame 24. The X-axis motor 26 includes a stepping motor, for example and is fixed to an underside of the frame 24. The X-axis motor 26 has a rotating shaft 26a which extends through a hole (not shown) of the second mounting frame 23 as shown in FIG. 1. The rotating shaft 26a has a distal end to which a driving gear 27a is fixed. A driven gear 27b is disposed in front of the driving gear 27a so as to be brought into mesh engagement with the driving gear 27a. The driven gear 27b is rotatably supported on the second mounting frame 24. The second reduction gear mechanism 27 is constituted by the driving and driven gears 27a and 27b. A pulley 28 is mounted on an upper surface of the drive gear 27b so as to be rotated together with the drive gear 27b. On the other hand, another pulley 29 is rotatably mounted on an upper surface of the right-hand first mounting frame 14 as viewed in FIG. 2. A timing belt 31 extends between the pulleys 28 and 29. The timing belt 31 is connected to a rear end of the carriage 20 (a mounting portion 30 (see FIG. 4B) as will be described later) and is of an endless type.

Upon drive of the X-axis motor 26, normal or reverse rotation of the X-axis motor 26 is transmitted via the second reduction gear mechanism 27 and the pulley 28 to the timing belt 31, whereby the carriage 20 is moved leftward or rightward together with the cutter holder 5. Thus, the carriage 20 and the cutter holder 5 are moved in the X direction perpendicular to the Y direction in which the object 6 is conveyed. The second moving unit 8 is constituted by the above-described guide shaft 21, the X-axis motor 26, the second reduction gear mechanism 27, the pulleys 28 and 29, the timing belt 31, the carriage 20 and the like.

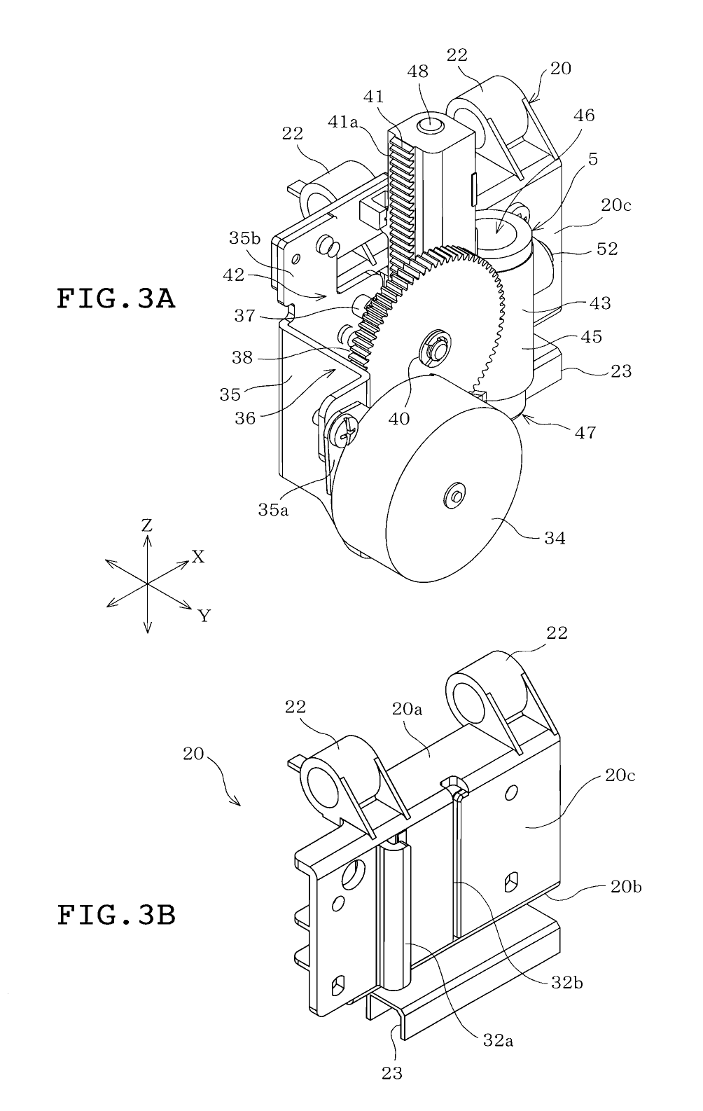

The cutter holder 5 is disposed on the front of the carriage 20 and is supported so as to be movable in a vertical direction (a third direction) serving as a Z direction. The carriage 20 has a front wall 20c generally formed into the shape of a rectangular plate as shown in FIG. 3B. The carriage 20 also has upper and lower edges 20a and 20c both of which are formed by folding upper and lower ends of the front wall 20c backward, respectively. A pair of right and left support portions 22 having respective through holes are formed on the upper edge 20a of the carriage 20 so as to jut upward. A guide 23 is formed integrally with the lower edge 20b of the carriage 20. The guide 23 extends in the right-left direction and has an open underside, so that the guide 23 has a generally U-shaped section. The guide 23 is engaged with the pinch roller 13 from above so as to slidable in the right-left direction. Furthermore, the front wall 20c of the carriage 20 is provided with a backwardly protruding mount portion 30, which is joined with the timing belt 31, as shown in FIG. 4B. The carriage 20 is thus supported on the guide shaft 21 inserted through the holes 22 so as to be slidable in the right-left direction. Furthermore, the guide 23 is slidably engaged with the pinch roller 13 with the result that the position of the carriage 20 is retained so that the carriage 20 is not turned about the guide shaft 21.

First and second engaging portions 32a and 32b vertically extend on the front wall 20c of the carriage 20 as shown in FIG. 3B. The first engaging portion 32a projects forward from the front wall 20c so as to be generally formed into an L-shape as viewed in a planar view, while the second engaging portion 32b is formed into the shape of a slit. The first and second engaging portions 32a and 32b are adapted to engage first and second engaged portions 33a and 33b of the cutter holder 5 (see FIG. 4B) respectively, thereby supporting the cutter holder 5 so that the cutter holder 5 is movable upward and downward.

A generally crank-shaped third mounting frame 35 is provided on a left part of the front wall 20c of the carriage 20 as shown in FIGS. 3A and 4B. A 2-axis motor 34 and the third reduction gear mechanism 36 are mounted on the third mounting frame 35. The Z-axis motor 34 includes a stepping motor and is fixed to as front of a from mount piece 35a of the third mounting frame 35. The 2-axis motor 34 has a rotating shaft 34a extending through a hole (not shown) of the mounting piece 35a as shown in FIG. 4B. The rotating shaft 34a has a distal end to which the driving gear 34b is fixed. On the other hand, a gear shaft 37 is mounted on a rear mount piece 35b of the third mounting frame 35 so as to protrude forward. An intermediate gear 38 and a pinion 39 having a smaller diameter are rotatably mounted on the gear shaft 37. A retaining ring 40 is secured to a front end of the gear shaft 37 to prevent the intermediate gear 38 and the pinion 39 from dropping out of the gear shaft 37. The intermediate gear 38 is brought into mesh engagement with the driving gear 34b. The pinion gear 39 is formed integrally with the intermediate gear 38. A third reduction gear mechanism 36 is constituted by the driving gear 34b, the intermediate gear 38 and the pinion 39.

The cutter holder 5 includes a holder body 43 having a left half shaft accommodation part 44 and a right half stepped cylindrical part 45 both of which are formed integrally with each other, as shown in FIGS. 3A and 4A-4C. The shaft accommodation part 44 is formed so as to extend vertically. The shaft accommodation part 44 is provided with a first engaged portion 33a located at a rear wall side thereof as shown in FIG. 4B. The cylindrical part 45 is provided with a second engaged portion 33b located at a rear wall side thereof. The first engaged portion as is formed so as to be engageable with the first engaging portion 32a of the carriage 20. The second engaged portion 33b is formed so as to be engageable with the second engaging portion 32b of the carriage 20. The holder body 43 is inserted into the carriage 20 downward from above while the first and second engaged portions 33a and 33b are engaged with the first and second engaging portions 32a and 32b respectively, thereby being assembled to the carriage 20. As a result, the holder body 43 is supported on the carriage 20 so as to be vertically movable.

The shaft accommodation part 44 of the holder body 43 is provided with a mounting shaft 48 which vertically extends through holes (not shown) of a bottom wall 44a and a shelf 44b of the shaft accommodation part 44. A pair of retaining rings 49 are attached to the mounting shaft 48 so that the bottom wall 44a and the shelf 44b are vertically interposed therebetween. The mounting shaft 48 is thus fixed to the holder body 43 by the retaining rings 49. A rack forming member 41 is disposed on the left of the mounting shaft 48. The rack forming member 41 has a rack 41a, and a pair of mounting pieces 41b and 41c all of which are formed integrally therewith. The rack 41a is brought into mesh engagement with the pinion 39 of the third reduction gear mechanism 36. The mounting pieces 41b and 41c extend rightward from an upper end and a middle portions of the rack 41a respectively.

The rack forming member 41 is mounted on the mounting shaft 48 extending through holes (not shown) of the mounting pieces 41b and 41c, so as to be axially movable, in this case, the rack forming member 41 is disposed the middle mounting piece 41c is located below the shelf 44b. Furthermore, a compression coil spring 50 is provided around the mounting shaft 48 so as to be located between the mounting piece 4c of the rack forming member 41 and the bottom wall 44a of the shaft accommodation portion 44.

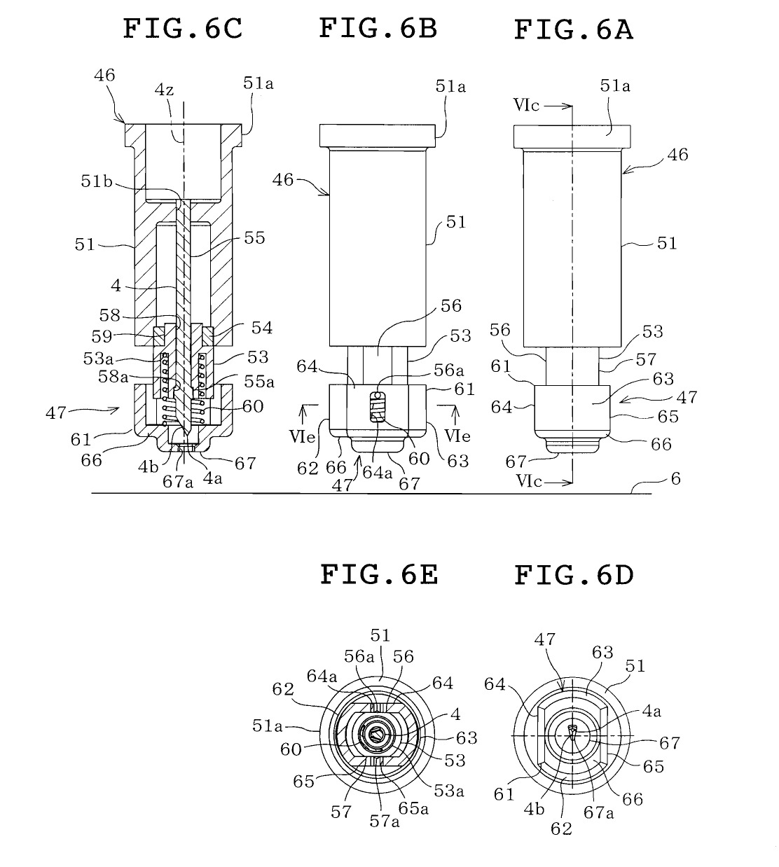

The rack 41a of the rack forming member 41 is brought into mesh engagement with the pinion 39 of the third reduction gear mechanism 36 as described above. Accordingly, upon drive of the Z-axis motor 34, normal or reverse rotation of the Z-axis motor 34 is transmitted via the driving gear 34b, the middle gear 38 and the pinion 39 to the rack forming member 41, so that the holder body 43 (the cutter holder 5) is moved upward or downward between a raised position and a lowered position. When the cutter holder 5 occupies the lowered position, the blade edge 4b of the cutter 4 penetrates the object 6 (see FIGS. 5 and 8C). When the cutter holder 5 occupies the raised position, the blade edge 4a is spaced away from the object 6 by a predetermined distance (see FIGS. 4C and 6C).

The compression coil spring 50 is compressed downward by the mounting piece 41c of the rack forming member 41 when the cutter holder 5 occupies the lowered position. Accordingly, a predetermined cutter pressure (force of the cutter 4 pressing the object 6) is obtained by a biasing force (elastic force) of the compression coil spring 50. On the other hand, the compression coil spring 50 allows the cutter holder 5 (the cutter 4) to move upward against the biasing force. A third moving unit 42 for vertically moving the cutter holder 5 is constituted by the first, second and third moving units 7, 8 and 42. The cutter holder 5 is provided with a retaining mechanism 46 and a press mechanism 47 both, disposed on a cylindrical portion 45 of the holder body 43. The cutter 4 is retained by the retaining mechanism 46 so as to be rotatable about the Z-axis. The object 6 is pressed by the press mechanism 47.

The constructions of the retaining mechanism 46, the cutter 4 and the press mechanism 47 will be described in detail with reference to FIGS. 6A to 6E, which are front, left side, longitudinally sectional left side, bottom and transversely sectional bottom views, as well as FIGS. 1 to 5. The retaining mechanism 46 includes a generally cylindrical retaining base member 51 disposed in the cylindrical portion 45 of the holder body 43 as shown in FIGS. 4C and 6A-6E. The retaining base member 51 has an upper end formed with a flange 51a which protrudes radially outward and is supported on the upper end of the cylindrical portion 45. The retaining base member 51 is accommodated into the cylindrical portion 45 from above and then fixed to the holder body 43 by a screw 52. In this case, the screw 52 radially extends through a slightly upper portion of the cylindrical portion 45, thereby locking, the retaining base member 51.

A bearing member 54 is fixed to a lower inner end of the retaining base in ember 51 as shown in FIG. 6C. The support base member also has a bearing portion 51b formed integrally with a middle or slightly upper inner part of the retaining base member 51. The bearing portion 51b is brought into sliding contact with an outer periphery of the cutter shaft 55 of the cutter 4. A bearing unit is constituted by the bearing member 54 and the bearing portion 51b.

The cutter 4 includes a cutter shaft 55 which serves as a base and is formed into the shape of a round bar and the blade edge 4b at the distal or lower end of the cutter shaft 55. The cutter shaft 55 and the blade edge 4b are formed integrally with each other. A fitting protrusion 55a is formed on a lower part of the cutter shaft 55 so as to protrude radially outward. The fitting protrusion 55a is fitted with a fitting support member 53 as will be described later. The blade edge 4b of the cutter 4 is inclined relative to the object 6 as shown in FIG. 5. The cutter 4 is formed into a tapered shape such that the cutter 4 becomes narrower as it goes toward the distal end of the blade edge 4b. The blade edge 4b includes a tip or a lowermost edge 4a which is formed so as to be eccentric by distance d with respect to a central axis 4z of the cutter shaft 55. The blade edge refers to a distal end of the cutter 4 cutting the object 6 and includes the point 4a in the configuration.

FIG. 6E shows a section taken along line VIe-VIe in FIG. 6B, that is, a section perpendicular to the Z direction in which the cutter 4 extends. As shown, the blade edge 4b side of the lower end of the cutter 4 has a generally triangular section. A through aperture 67a (see FIG. 6D) through which the blade edge 4b penetrates is formed into a generally triangular shape substantially homologous with the above-mentioned triangular section. The cutter 4 is set at a height such that the blade edge 4b penetrates the object 6 on the holding sheet 10 and does not reach the upper surface of the plate member 3b of the platen 3 when the cutter holder 5 has been moved to the lowered position, as shown in FIG. 5.

The fitting support member 53 has a diameter set to be smaller than that of the retaining base member 51, as shown in FIGS. 6A, 6B and 6E. The fitting support member 53 has a pair of flat portions 56 and 57 formed on an outer periphery thereof and is accordingly formed into an elliptical shape as viewed axially. Both flat portions 56 and 57 extends in the direction of the central axis 4z. The flat portions 56 and 57 have small protrusions 56a and 57a which are formed so as to be located symmetrically with respect to the central axis 4z. The fitting support member 53 has an axially extending through hole 58 as shown in FIG. 6C. A cutter shaft 55 is force fitted into the hole 58. The fitting support member 53 has a lower end formed with a fitting recess 58a formed by axially outwardly indenting a part of an inner peripheral wall defining the hole 58. The fitting protrusion 55a of the cutter shaft 55 is configured to be fitted with the fitting recess 58a. The cutter shaft 55 is force fitted into the hole 58 of the fitting support member 53 until the fitting protrusion 55a is fitted with the lining recess 58a, thereby being assembled to the fitting support member 53. In this case, the cutter shaft 55 is assembled to the fitting support member 53 so that the fiat portions 56 and 57 of the fitting support member 53 are in parallel with the orientation of the blade edge 4b. Thus, the cutter 4 is fixed to the fitting support member 53.

The fitting support member 53 has an upper end formed with a stepped supported portion 59. The cutter 4 is assembled to the fitting support member 53 so that both are formed into a single piece, as described above. In this state, the supported portion 59 of the fitting support member 53 is rotatably inserted via the bearing member 54 into the retaining base member 51. The fitting support member 53 has a spring accommodation groove 53a which is formed radially outside the hole 58 so as to be coaxial with the hole 58. The spring accommodation groove 53a is formed so as to extend upward from the lower end of the fitting support member 53. An upper half of a compression coil spring 60 which will be described later is to be accommodated in the spring accommodation groove 53a. The above-described retaining base member 51, the bearing member 54 and the fitting support member 53 serve as a supporting unit which supports the cutter 4 so that the cutter 4 is rotatable about the central axis 4z, thereby constituting, the retaining mechanism 46.

The press mechanism 47 serves as a pressing unit and includes a press member 61 and the compression coil spring 60. The press member 61 is configured to press the object 6 and the compression coil spring 60 is configured to elastically bias the press member 61 to the object 6 side. The press member 61 is made of a resin material and is formed into a cup shape so as to accommodate a lower part of the fitting support member 53. The press member 61 has an outer periphery including a pair of curved walls 62 and 63 and a pair of flat walls 64 and 65 continuous from side edges of the curved walls 62 and 63 respectively (see FIGS. 6D and 6E). The press member 61 has an outer periphery that is formed into an elliptical shape as viewed axially. The curved walls 62 and 63 are formed so as to have larger diameters than an outer periphery of the fitting support member 53. More specifically, a predetermined space (a gap) is defined between inner surfaces of the curved walls 62 and 63 and the outer periphery of the fitting support member 53. On the other hand, the inner surfaces of the flat walls 64 and 65 is brought into sliding contact with the flat portions 56 and 57 of the fitting support member 53. The flat walls 64 and 65 are formed with a pair of windows 64a and 65a opposed to each other, respectively. The small protrusions 56a and 57a of the fitting support member 53 are viewable through the windows 64a and 65a respectively. The windows 64a and 65a are formed into generally rectangular holes respectively.

The press member 61 has a bottom wall 66 provided with a downwardly protruding contact portion 67. The contact portion 67 has a lower end surface that is a circular horizontal flat surface. The contact portion 67 is brought into surface contact with the object 6. The contact portion 67 has a lower ridge line formed into a curved surface (round chamfering). The contact portion 67 has a through aperture 67a extending therethrough in the up-down direction in which the cutter 4 extends. The aperture 67a is formed into a generally triangular shape that is substantially homologous with the section of the blade edge 4b side of the cutter 4, as shown in FIG. 6D. The direction in which the aperture 67a extends (an up-down direction on the drawing paper of FIG. 6D) is in parallel to the flat walls 64 and 65. In this case, the aperture 67a is dimensioned so as to be slightly larger than the section of the blade edge 4b side so that the press member 61 engages the blade edge 4b with a small gap between the blade edge 4b and the inner periphery of the aperture 67a. As shown in FIG. 5, a gap designated by symbol G1 is defined between the inner wall surface of the aperture 67a and the cutter 4 at the side opposite to the direction of relative movement of the cutter 4 as shown by arrow. Furthermore, the aperture 67a is formed eccentrically so as to be located nearer to the blade edge 4a relative to the central axis 4z in the contact portion 67, as shown in FIGS. 6C and 6D. Thus, the press member 61 is configured so that the tip 4a of the blade edge 4b can smoothly be inserted through the aperture 67a and so that the press member 61 is engageable with the blade edge 4b side in the aperture 67a.

The compression coil spring 60 serves as a biasing member which biases the press member 61 toward the object 6. The compression coil spring 60 is disposed between the bottom wall 66 of the press member 61 and the spring accommodation groove 53a of the fitting support member 53. The compression coil spring 60 is assembled to the fitting support member 53 from below together with the press member 61. In the assembly, the orientation of the through aperture 67a of the press member 61 (the orientation of substantially triangular hole) is matched with that of the blade edge 4b of the cutter 4 fitted in the fitting support member 53. The inner surfaces of the flat walls 64 and 65 of the press member 61 are placed along the flat portions 56 and 57 of the fitting support member 53 to be attached to the fitting support member 53. In this case, the press member 61 is pushed upward against the elastic force of the spring 60 in the compression direction. As a result, upper ends of the flat walls 64 and 65 are fitted into the fitting support member 53 while being elastically deformed outward so as to get over the protrusions 56a and 57a, respectively. When the windows 64a and 65a of the press member 61 reach the protrusions 56a and 57a, the upper ends of the flat walls 64 and 65 flexed outwards return to the original states, respectively. Thus, the windows 64a and 65a are engageable with the protrusions 56a and 57a respectively and the assembly is completed.

The press member 61 is thus connected via the compression coil spring 60 to the fitting support member 53. Accordingly, the press member 61 is biased to the object 6 side by the compression coil spring 60. Furthermore, since the flat walls 64 and 65 of the press member 61 are brought into surface contact with the flat portions 56 and 57 of the fitting support member 53, the press member 61 is rotated together with the cutter 4 and the compression coil spring 60. Thus, the press device 47 is configured so that the press member 61 interlocks with the blade edge 4b thereby to be rotated, with the change in the orientation of the blade edge 4b. Furthermore, since the predetermined spaces (gaps) are defined between the inner surfaces of the curved walls 62 and 63 and outer peripheral curved surfaces of the fitting support member 53 respectively, the press mechanism is allowed to move by the spaces in the direction of extension of the aperture 67a relative to the fitting support member 53. In other words, the press member 61 is movable in a direction in which the aperture 67a is brought into contact with the blade edge 4b of the cutter 4.

The press member 61 is locked at the upper edges of the windows 64a and 65a by the protrusions 56a and 57a when the cutter holder 5 is located at the raised position, as shown in FIG. 6B. Accordingly, the press member 61 is prevented from falling off the fitting support member 53 even when subjected to the biasing force of the compression coil spring 60. Furthermore, when the cutter holder 5 is located at the raised position, the blade edge 4a is accommodated in the press member 61 thereby to be prevented from being exposed. On the other hand, when the cutter holder 5 is located at the lowered position, the compression coil spring is further compressed as shown in FIG. 8C. The biasing force (elastic force) of the compression coil spring 60 presses the press member 61 downward, whereby the object 6 is pressed by the press member 61.

A frictional force is generated between the contact portion 67 and the object 6 during feeding that will be described later or cutting. As a result, the press member 61 is moved in the direction in which the press member 61 contacts the blade edge 4. More specifically, the blade edge 4b contacts the aperture 67a without space therebetween during the feeding.

The holding sheet 10 has an adhesive layer 10v which holds the object 6 as shown in FIG. 5. The object 6 is immovably held on the holding sheet 10 by adhesion of the adhesive layer 10v and a pressing force of the press mechanism 47. The holding sheet 10 is made of, for example, a synthetic resin and formed into a flat rectangular plate shape, as shown in FIG. 1. The adhesive layer 10v is formed by applying an adhesive agent to an upper side of the holding sheet 10, that is, a side opposite the cutter 4. The sheet-like object 6 such as paper, cloth, resin film or the like is removably held by the adhesive layer 10v. The adhesive layer 10v has an adhesion that is set to a small value such that the object 6 can easily be removed from the adhesive layer 10v without breakage of the object 6.

The arrangement of the control system of the cutting plotter 1 will now be described with reference to a block diagram of FIG. 9. A control circuit (a control unit) 71 controlling the entire cutting plotter 1 mainly comprises a computer (CPU). A ROM 72, a RAM 73 and an external memory 74 each serving as a storage unit are connected to the control circuit 71. The ROM 72 stores a cutting control program for controlling the cutting operation, a cutting data processing program and the like. The RAM 73 is provided with storage areas for temporarily storing various data and program to execute each processing. The external memory 74 stores a plurality of types of cutting data. The cutting data includes data of line segments corresponding to n—number of line segments L₁ to Lₙ composing a cutting line L.

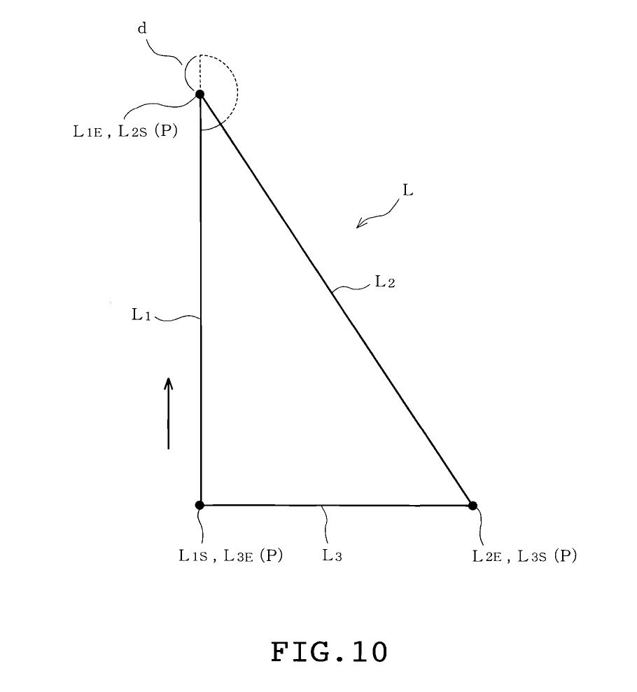

For example, as shown in FIG. 10, assume a case where a pattern of “triangle” is cut from the object 6 that is sheet held on the holding sheet 10, such as paper. In this case, cutting data has data of three line segments including three line segments L₁ to L₃ composing the cutting line L. More specifically, the line segments L₁ to L₃ have start points L_{1S} to L_{3S} and end points L_{1E} to L_{3E} respectively. Furthermore the line segments L₁ to L₃ are continuous and compose a single closed cutting line L. Accordingly, the start point of each line segment corresponds with the end point of neighboring line segment, and the end point of each line segment corresponds with the start point of neighboring line segment. The start and end points of the line segments L₁ to L₃ are represented by X-Y coordinates.

Operation signals generated by various operation switches of the operation device 9b are supplied to the control circuit 71. The control circuit 71 controls a displaying operation of a liquid-crystal display (LCD) 9a. In this case, while viewing the displayed contents of the LCD 9a, the user operates various operation device 9b to select and designates cutting data of a desired shape. Detection signals generated by various detection sensors 75 are supplied to the control circuit 71. The detection sensors 75 include one for detecting the holding sheet 10 set through the opening 2a of the cutting plotter 1. Drive circuits 76, 77 and 78 driving the Y-axis motor 15, the X-axis motor 26 and the Z-axis motor 34 are also connected to the control circuit 71. The control circuit 71 executes the cutting control program to control various actuators of the Y-axis motor 15, the X-axis motor 26, the Z-axis motor 34 and the like based on the cutting data, thereby executing automatic cutting of the object 6 on the holding sheet 10.

The cutting plotter constructed as described above will work as follows. In the following description, the aforementioned “triangle” will be cut as the shape to be cut and general paper is used as the object 6.

The cutter holder 5 occupies the raised position before the cutting of the object 6 starts by the cutting plotter 1. When the cutter holder 5 occupies the raised position, the blade edge 4b thereof is accommodated in the press member 61 thereby not to be exposed, as shown in FIG. 6C. The press member 61 is held at a central position so that the blade edge 4b and the aperture 67a extends in the same direction and the outer peripheral curved walls 62 and 63 extend in the same direction as the outer periphery of the retaining base member 51, as viewed from the direction of the central axis 4z as shown in FIG. 6D. On the other hand, the object 6 is attached to the adhesive layer 10v thereby to be held on the holding sheet 10. The holding sheet 10 is then set through the opening 2a of the cutting plotter 1. The user then selects desired cutting data from cutting data stored in the external memory 74, for example. The selected cutting data is read out from the external memory and stored in a memory of the RAM 73. When the operation device 9b is operated, the control circuit 71 starts the cutting operation based on an operation signal.

In the cutting operation, the X axis and Y axis motors 15 and 26 are driven based on the cutting data to relatively move the cutter 4 so that the tip 4a thereof is represented as X-Y coordinates (see FIG. 10) of start point L_{1S} of line segment L₁. Next, the Z-axis motor 34 is driven with the cutter 4 occupying the cutting start point L_{1S} to move the cutter holder 5 to the lowered position. As a result, the object 6 is pressed by the contact portion 67 of the press member 61 and the tip 4a of the cutter 4 penetrates the object 6 downward from the aperture 67a of the press member 61 thereby to reach the cutting start point L_{1S} of the object 6 (see FIG. 8C).

The motors 15 and 26 are driven so that the cutter 4 and the object 6 are relatively moved toward the coordinate of end point L1E of line segment L1, whereby the cutting of the object 6 is started. The cutter 4 is subjected to resistive force from the object 6 with the relative movement of the cutter 4 during the cutting. The press member 61 presses the object 6 at a position where the press member 61 surrounds the blade edge 4b. Accordingly, a frictional force caused between the contact portion 67 of the press member 61 and the object 6 displaces the press member 61 in a direction such that the blade edge 4b and the aperture 67a contact each other without gap. Reference symbol D1 in FIGS. 5D and 8D designates an amount of displacement of the press member 61 relative to the central axis 4z. Thus, when the object 6 is cut along the line segment L1 of the cutting line L in the direction of arrow in FIG. 10, the press member 61 engages the blade edge 4b in the aperture 67a thereby to press the object 6 with the contact portion 67 being situated close to the blade edge 4b.

When the tip 4a of the cutter 4 has reached the apex P (end point L_{1E}), the central axis 4z of the cutter shaft 55 occupies a position that is on an extension of line segment L1 as shown in FIG. 10 and is spaced away from the apex P by a distance d. The cutter 4 is then moved so that the central axis 4z moves along the broken line (arc) in FIG. 10, whereby the orientation of the blade edge 4b is changed at the apex P. In other words, the cutter 4 is rotated about the central axis 4z until the blade edge 4b is oriented to the direction along the line segment L₂. With change in the orientation of the blade edge 4b, furthermore, the press member 61 interlocks with the cutter 4 thereby to be rotated with the cutter 4. As a result, the press member 61 is retained in the object 6 pressing state at the position where the contact portion 67 is in proximity to the blade edge 4b.

The blade edge 4b penetrates the object 6 and bites slightly into the holding sheet 10 as shown in FIG. 5. Accordingly, the blade edge 4b slightly pries the part of apex P. Furthermore, the part of the apex P in the cutting line L has an area contacting the adhesive layer 10v. This area is gradually rendered smaller as the cutting line L approaches the distal end. Accordingly, adhesion of the adhesive layer 10v becomes lower in the part of apex P so that the part of apex P is easy to result in floating or turning. In this regard, the press member 61 in the configuration is retained at the position the press member 61 presses the object 6 near the blade edge 4b by the cooperation with the blade edge 4b. As a result, the region of the part of apex P can be pressed by the press member 61 thereby to be retained so as not to cause turning.

After the direction of the cutter 4 has been changed so that the blade edge 4b is in parallel to the line segment L₂, cutting of the line segment L₂ is carried out in the same manner as the line segment L₁ while the object 6 is pressed by the press member 61 near the blade edge 4b. Regarding the cutting of the line segment L₃, the pressing action of the press member 61 can be achieved in the same manner as the line segments L₁ and L₂. Thus, when the line segments L1 to L3 are cut, the object 6 is normally pressed by the press member 61 near the blade edge 4b thereby to be retained so as not to cause floating or turning. This can realize cutting of the cutting line L of a good-looking triangle.

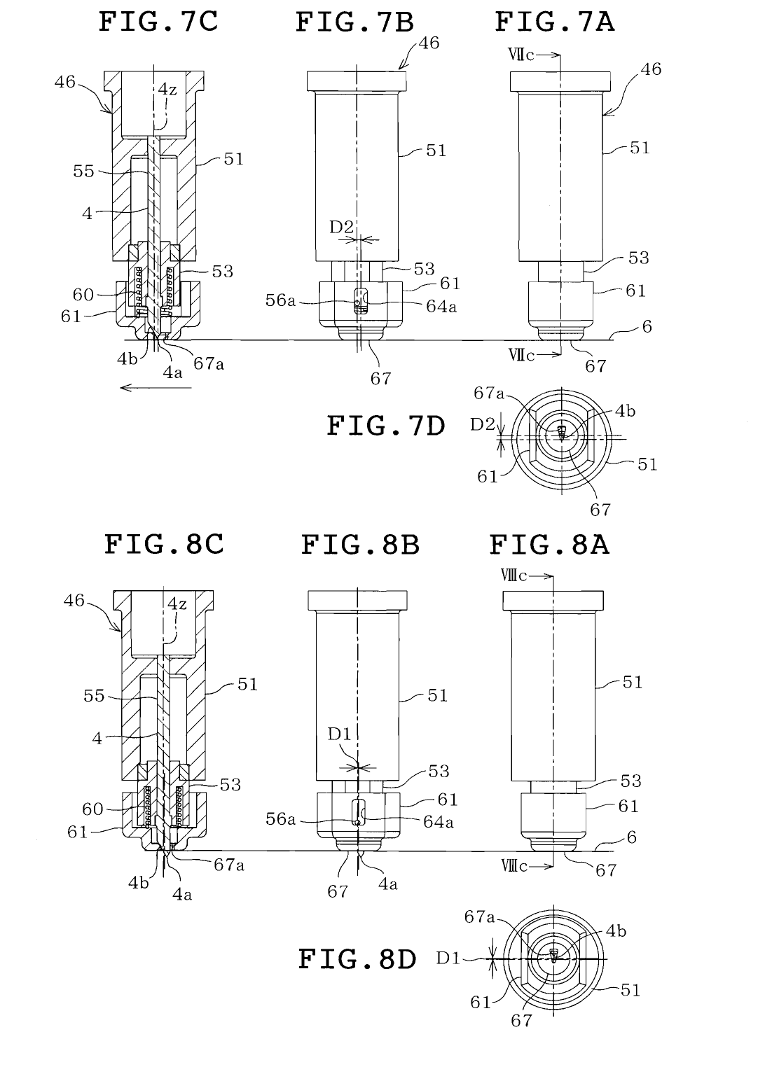

Suppose now that a plurality of patterns, for example, two “triangles” are to be cut from the object 6 on the holding sheet 10. In this case, in addition to the above-described operation of the cutter holder 5, the cutter's movement between the initially cut “triangle” and the next cut “triangle,” that is, the movement of the cutter holder 5 in the feed without cutting are executed. More specifically, after the cutting line L of the first “triangle” has been cut, the tip 4a of the cutter 4 is slightly separated from the object 6 by the third moving rum 42 (see FIG. 7C). In this state, the tip 4a is relatively moved to a position corresponding to the cutting start point of the next (second) “triangle” by the first and second moving units 7 and 8. This relative movement is unloaded feed that is not accompanied by the cutting of the object 6 and is a linear movement. In this case, the press member 61 is kept pressing the object 6 as shown in FIGS. 7A to 7C. As a result, the frictional force between the contact portion 67 and the object 6 displaces the blade edge 4b and the aperture 67a in a direction such that the contact member 67 and the object 6 are brought into contact with each other without gap. Arrow in FIG. 7C designates a movement direction of the whole cutter holder 5. Reference symbol D2 in FIG. 7D designates an amount of displacement of the press member 61 relative to the central axis 47. As understood from the comparison of FIGS. 7C and 7D and FIGS. 8C and 8D, the amount of displacement of the press member 61 is increased according to an amount of rise of the blade edge 4b since the cutter 4 is tapered (D2>D1).

In the feed, too, the press member 61 presses the object 6 while the blade edge 4b of the cutter 4 and the aperture 67a of the contact portion 67 are in engagement with each other without gap. When the tip 4a of the cutter 4 reaches a position corresponding to a next cutting start point, the tip 4a is caused to penetrate the object 6 at the cutting start point downward from the aperture 67a (see FIG. 8C). In this case, the cutter 4 is moved downward while the blade edge 4b is in engagement with the aperture 67a. With this downward movement of the cutter 4, the press member 61 is pushed back to the central axis 4z side. Accordingly, the press member 61 presses the object 6 at the cutting start point while engaging the blade edge 4b in the aperture 67a.

Subsequently, the motors 15 and 26 are driven to start the cutting with respect to the second “triangle.” Suppose now that the cutting line L of this pattern includes a gentle curve with a large curvature radius, differing from the configuration of the first “triangle.” In this case, the orientation of the blade edge 4b is automatically changed along the direction of relative movement. Furthermore, the press member 61 interlocks with the cutter 4 to be rotated with the cutter 4 with the change in the orientation of the blade edge 4b. Accordingly, the object 6 is normally kept pressed by the press member 61 near the blade edge 4b from the cutting start point to the cutting end point of the cutting line L.

As described above, the cutter holder 5 in the configuration includes, as the cutting unit, the cutter 4 having, at the distal end, the blade edge 4b eccentric relative to the central axis 4z of the base extending in one direction, the retaining mechanism 46 rotatably retaining the cutter 4 about the central axis 4z and the press mechanism 47 which has the press member 61 formed so as to surround the blade edge 4b and pressing the object 6. In the relative movement of the cutter holder 5 and the object 6, the cutter 4 is moved about the central axis 4z so that the orientation of the blade edge 4b is changed. The press member 61 is configured to interlock with the blade edge 4b thereby to be rotated, with this change in the orientation of the blade edge 4b.

According to the above-described construction, the press member 61 interlocks with the blade edge 4b thereby to be rotated about the central axis 4z even when the orientation of the blade edge 4b is changed according to the direction in which the cutter 4 and the object 6 are relatively moved. As a result, the press member 61 is kept pressing, the object 6 at the position surrounding the blade edge 4b with the blade edge 4b not colliding against the press member 61. Accordingly, the pan of the object 6 located near the blade edge 4b is normally pressed by the press member 61, whereupon the object 6 can accurately be cut with prevention of the floating and turning of the object 6.

The press mechanism 47 includes the compression coil spring 60 serving as a biasing member which biases the press member 61 to the object 6 side. According to the construction, the press member 61 can press the object by the biasing force of the compression coil spring 60. Consequently, the floating and the turning of the object 6 can be prevented further reliably in the cutting.

The press member 61 is connected via the compression coil spring 60 to the retaining mechanism 46. According to the construction, the press member 61 can be connected to the retaining mechanism 46 using the compression coil spring 60, whereupon the retaining structure for the press member 61 can be simplified.

The press member 61 includes the contact portion 67 brought into contact with the object 6 and the through aperture 67a extending through the contact portion 67 in the direction in which the cutter 4 extends. The press member 61 is configured to be engageable with the blade edge 4b side of the cutter 4 in the aperture 67a. According to the construction, the press member 61 can be arranged in proximity to the cutter 4 so as to engage the blade edge 4b. Consequently, the object 6 can reliably be pressed in the part thereof around the blade edge 4b by the contact portion 67 of the press member 61 so that the object 6 is prevented from floating or turning.

The cutter 4 is formed into the tapered shape m which the cutter 4 has a narrower distal end. Since thus formed into the tapered shape, the blade edge 4b can easily be inserted through the aperture 67a. Furthermore, the through aperture 67a is substantially homologous with the section of the blade edge 4b side perpendicular to the direction in which the cutter 4 extends. Consequently, the distance between the press member 61 and the blade edge 4b around the cutter 4 can be rendered as small as possible (see FIG. 13B showing a second configuration).

The press member 61 is held by the compression coil spring 60 so as to be movable in the direction that is perpendicular to the direction in which the cutter 4 extends and in which the blade edge 4b and the aperture 67a are brought into contact with each other without gap. According to the construction, the contact portion 67 is subjected to the frictional force from the object 6 during the cutting, so that the blade edge 4b and the aperture 67a are moved in the direction such that the blade edge 4b and the aperture 67a are brought into contact with each other without gap. As a result, the contact portion 67 of the press member 61 can press the object 6 occupying the position immediately before the cutting by the blade edge 4b, whereupon the object 6 can further reliably be prevented from the floating or the turning. The press member 61 may not be configured to be held by the compression coil spring 60 so that the blade edge 4b and the aperture 67a are movable in the direction such that the blade edge 4b and the aperture 67a are brought into contact with each other without gap. The press member 61 may be held by the compression coil spring 60 so as to be movable in a direction such that the blade edge 4b and the aperture 67a are brought into contact with each other substantially without gap. This construction can achieve the same advantageous effect as described above.

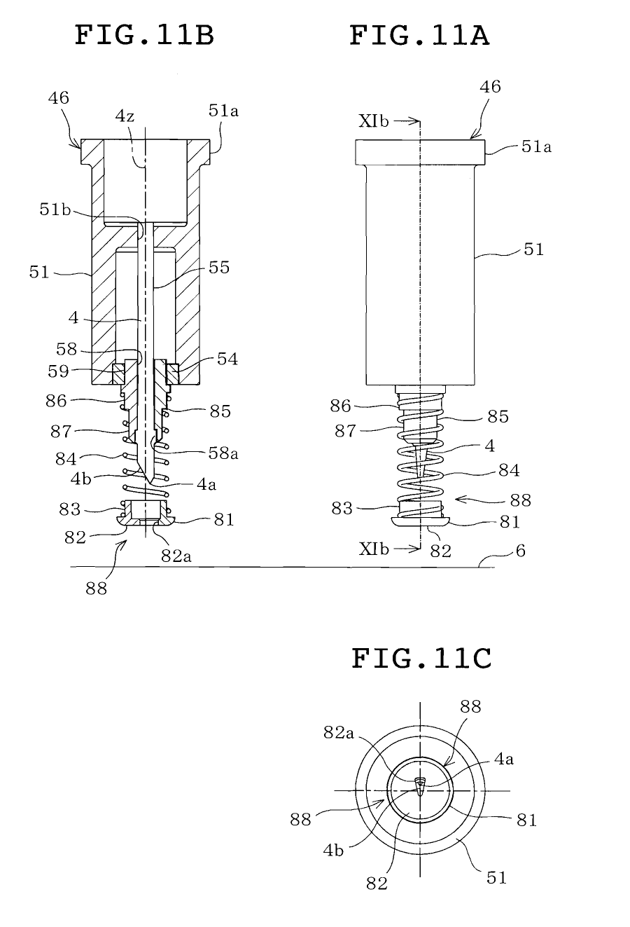

FIGS. 11A to 13C illustrate a second configuration. Only the differences between the first and second configurations will be described. Identical or similar parts in the second configuration are labeled by the same reference symbols as those in the first configuration.

A press mechanism 81 in the second configuration has a discoid contact portion 82 and a cylindrical portion 83 located at the upper surface side of the contact portion 82 as shown in FIGS. 11A to 11C. The contact portion 82 and the cylindrical portion 83 are formed integrally with each other. The contact portion 82 and the cylindrical portion 83 are integrally thrilled into the shape of a bottomed shallow cylindrical container. The cylindrical portion 83 has a smaller diameter than an outer shape of the contact portion 82. The contact portion 82 has a flat surface which is brought into surface contact with the object 6 at the underside thereof in the same manner as the contact portion 67 in the first configuration. The contact portion 82 has a through aperture 82a that is the same as the through aperture 67a in the first configuration.

In FIGS. 13A to 13C, an amount of protrusion of the blade edge 4b from the aperture 82a is slightly increased as compared with the first configuration, regarding the cutter 4 located at the lowered position of the cutter holder 5. In this case, too, the aperture 82a is provided with a sufficient gap G2 allowing engagement with and disengagement from the cutter 4 (see FIG. 13B). In this case, furthermore, the press mechanism 81 engages the blade edge 4b in the aperture 67a when the cutter holder 5 is moved from the raise position to the lowered position. Accordingly, the press mechanism 81 presses the object 6 from the cutting start point: while the blade edge 4b and the aperture 67a are in contact with each other.

The fitting support member 85 in the second configuration has an outer periphery formed with a first stepped portion 86 and a second stepped portion 87, instead of the spring accommodation groove 53a in the first configuration, as shown in FIG. 11B. The first stepped portion 86 is fitted inside the coil spring 84 thereby to lock the coil spring 84. The second stepped portion 87 has a smaller outer diameter than the first stepped portion 86. The cylindrical portion 83 of the press mechanism 81 has the same outer diameter as the first stepped portion 86. The cylindrical portion 83 is fitted inside the coil spring 84 thereby to lock the coil spring 84. More specifically, the upper end of the coil spring 84 is locked to the upper end side of the first stepped portion 86 of the fitting support member 85, and the lower end of the coil spring 84 is locked to the lower end side of the cylindrical portion 83 of the press mechanism 81. Accordingly, the press mechanism 81 is connected via the coil spring 84 serving as the biasing member to the fitting support member 85. The press mechanism 81 is configured to be rotated together with the fitting support member 85, the cutter 4 and the cod spring 84. Furthermore, the press mechanism 81 is movable in to direction such that the aperture 67a is brought into contact with the coil spring 84, as the result of the horizontal elastic deformation of the coil spring 84. The above-described press mechanism 81 and the coil spring 84 constitute the pressing device 85 (pressing unit) in the second configuration.

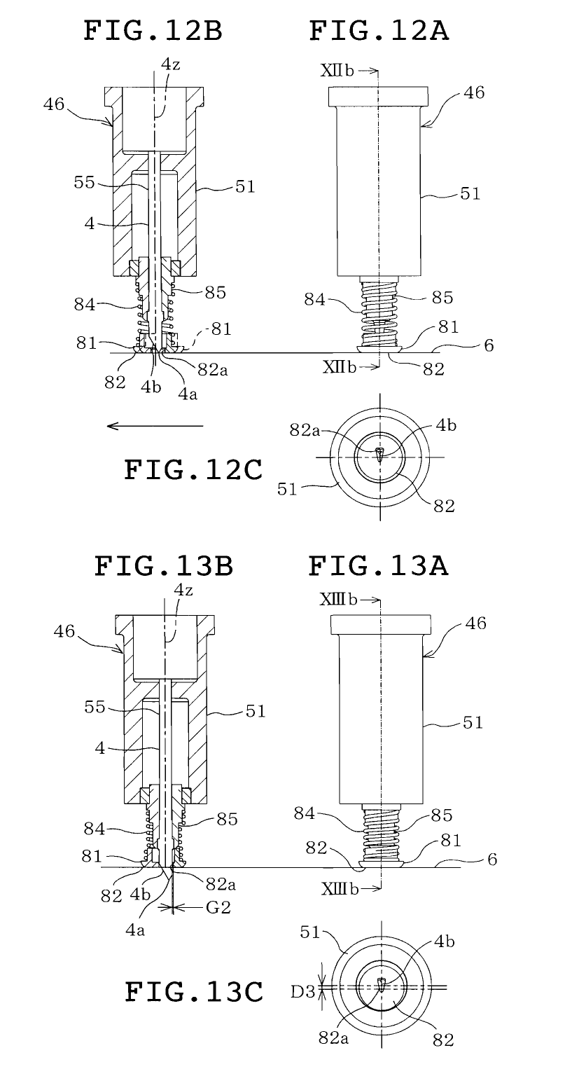

The blade edge 4b is not protruded from the press mechanism 81 and is surrounded by the coil spring 84 when the cutter holder 5 occupies the raised position, as shown in FIG. 11A. In this state, the Z-axis motor 34 is driven to move the cutter holder 5 to the lowered position. In this case, as shown in FIG. 12B, before the blade edge 4b reaches the object 6, the contact portion 82 of the press mechanism 81 is brought into contact with the object 6, whereby the coil spring 84 is compressed. As a result, the pressing force of the press mechanism 81 acts on the object 6. The press mechanism 81 engages the blade edge 4b in the aperture 67a when the tip 4a of the cutter 4 penetrates the object 6 downward from the aperture 67a of the press member 61 thereby to reach the cutting start point L_{1S} of the object 6. Consequently, when the cutter holder 5 occupies the lowered position, the tip 4a is displaced from the central axis 4z of the press mechanism 81 by a displacement amount D3 as shown in FIGS. 13B and 13C. In this case, furthermore, the blade edge 4b and the aperture 67a are in contact with each other without gap when the tip 4a occupies the cutting start point. This can realize the muting operation while the object 6 is normally pressed near the tip 4a in the entire stage from the cutting start point to the cutting end point.

On the other hand, suppose now that the whole cutter holder 5 is moved in the direction of arrow in FIG. 12B in the feeding. In this case, the frictional force caused between contact portion 82 and the object 6 displaces the press mechanism in the direction (see the broken line in FIG. 12B) such that the blade edge 4b and the aperture 67a are brought into contact with each other without gap in the same manner as in the first configuration. Accordingly, in the next cutting of the cutting line L after the feeding, the press mechanism 81 can also be retained in the pressing state in which the object 6 is pressed near the blade edge 4b.

The configurations described above with reference to the drawings should not be restrictive but may be modified or expanded as follows. Although the cutting apparatus 1 is applied to the cutting plotter in each configuration, the cutting apparatus 1 may be applied to various devices and apparatuses each having a cutting function.

Any type of cutter having a blade edge may be used, and the blade edge should not be limited to the substantially triangular shape. The cutter base may be formed into a flat shape instead of the rounded bar-shaped cutter shaft 55. In this case, the flat-plate shaped base is supported using a fitting support member that is fitted in the cutter. Furthermore, the cutter can rotatably be supported via the fitting support member by a bearing unit. Any type of supporting unit may be used that supports the cutter so that the orientation of the blade edge is changeable. An actuator may be provided for changing the orientation of the blade edge.

The biasing member of the pressing unit should not be limited to the above-described coil spring 60 or 84. An elastic bellows-shaped rubber member or urethane foam may serve as the biasing member which biases the press mechanism to the object 6 side. Furthermore, the biasing member may be eliminated when the object 6 is pressed by the self-weight of the press mechanism. The pressing unit may include a drive mechanism which maintains the position where the press mechanism presses the object in conjunction with the blade edge near the blade edge with the change in the orientation of the blade edge of the cutter. The construction can achieve the same advantageous effect as the above-described configurations.

The foregoing description and drawings are merely illustrative of the present disclosure and are not to be construed in a limiting sense. Various changes and modifications will become apparent to those of ordinary skill in the art. All such changes and modifications are seen to fall within the scope of the appended claims.

What is claimed

1. A cutting plotter comprising:
a cutting mechanism comprising a cutter, the cutter having a blade edge on a head of the cutter;
a retaining mechanism retaining the cutter to allow the cutter to change an orientation of the blade edge;
a press mechanism comprising a press member, the press member being configured to interlock with the cutter and to press a cutting object near the blade edge, wherein
when the orientation of the blade edge changes in a relative movement between the cutting mechanism and the cutting object, the press mechanism being configured to maintain a positional relationship between the press member and the blade edge.

2. The cutting plotter according to claim 1, wherein
the press mechanism further comprises a biasing member that biases the press member toward the cutting object.

3. The cutting plotter according to claim 2, wherein
the press member is connected to the retaining mechanism via the biasing member.

4. The cutting mechanism according to claim 1, wherein
the press member has a contact portion to which the cutting object contacts and an aperture penetrating the contact portion in a first direction along which the cutter extends, and wherein
the press member is configured to contact to a blade edge side of the cutter on an inner surface of the aperture.

5. The cutting plotter according to claim 4, wherein
the cutter tapers toward a tip of the blade edge, and wherein
the aperture is formed to be homologous with a cross-section of the cutter that is perpendicular to the first direction and includes the blade edge.

6. The cutting plotter according to claim 5, wherein
the press mechanism further comprises a biasing member that biases the press member toward the cutting object, and wherein
the biasing member retains the press member movably in a direction in which the aperture contacts to the blade edge and which is perpendicular to the first direction.

7. A cutting plotter comprising:
a cutting mechanism comprising a cutter, the cutter having a blade edge on a head of the cutter and a tip of the blade edge, the tip of the blade edge being eccentric with respect to a central axis of a base portion of the cutter, the base portion extending in one direction;
a retaining mechanism retaining the cutter pivotably about the central axis;
a press mechanism comprising a press member, the press member surrounding the blade edge and being configured to pivotably interlock with the cutter and to press a cutting object, wherein
when an orientation of the blade edge changes due to a pivot of the cutter about the central axis in a relative movement between the cutting mechanism and the cutting object, the press mechanism being configured to maintain a positional relationship between the press member and the blade edge by a pivot of the press member.

8. The cutting plotter according to claim 7, wherein
the press mechanism further comprises a biasing member that biases the press member toward the cutting object.

9. The cutting plotter according to claim 8, wherein
the press member is connected to the retaining mechanism via the biasing member.

10. The cutting plotter according to claim 7, wherein
the press member has a contact portion to which the cutting object contacts and an aperture penetrating the contact portion in a first direction along which the cutter extends, and wherein
the press member is configured to contact to a blade edge side of the cutter on an inner surface of the aperture.

11. The cutting plotter according to claim 10, wherein
the cutter tapers toward the tip of the blade edge, and wherein
the aperture is formed to be homologous with a cross-section of the cutter that is perpendicular to the first direction and includes the blade edge.

12. The cutting plotter according to claim 1, wherein
the press mechanism further comprises a biasing member that biases the press member toward the cutting object, and wherein
the biasing member retains the press member movably in a direction in which the aperture contacts to the blade edge and which is perpendicular to the first direction.
